(19) United States
(12) Patent Application Publication
(10) Pub. No.: US 2014/0212286 A1
(43) Pub. Date: Jul. 31, 2014

(54) Device of a Self-Adjusting Foil Suspension

(71) Applicant: Tidal Sails AS, Haugesund (NO)

(72) Inventor: Are Borgesen, Haugesund (NO)

(73) Assignee: Tidal Sails AS, Haugesund (NO)

(21) Appl. No.: 14/239,080

(22) PCT Filed: Sep. 19, 2012
(86) PCT No.: PCT/NO2012/050178

§ 371 Date: Feb. 14, 2014

(30) Foreign Application Priority Data
Sep. 21, 2011 (NO) 20111280

(51) Int. Cl. F03B 17/06

(52) U.S. Cl. CPC F03B 17/066
USPC 416/8

(57) ABSTRACT

A device is of a self-adjusting foil suspension in which a foil is placed in a fluid flow, typically a tidal flow. The foil is rotatable around a rotational axis, and the foil is connected by means of an arm to a track. The arm is rotatable around the rotational axis and rotatably connected to the track around a suspension axis at a radial distance from the rotational axis, the suspension axis being parallel to the rotational axis.

This invention relates to a self-adjusting foil suspension. More particularly, it relates to a self-adjusting foil suspension in which a foil is placed in a fluid flow, typically in a tidal flow, and in which the foil is rotatable around a rotational axis.

By the term “foil” is meant, in this connection, a whole or compound body formed to provide a favourable flow pattern when energy is being extracted from flowing water. The term also includes sails which are used for the same purpose.

It is known to attach foils rotatably to a belt extending over pulleys in a flow of water. GB document 2131490 thus discloses a plant for extracting energy from wind and flowing water, wherein two belts extend in parallel in a triangular shape, and wherein, between the belts, there are foils arranged that are rotatably arranged to adjust themselves according to the fluid flow. The suspension of the foils is relatively simple and will only to a limited degree be able to place itself at the angles that are the most favourable under different flow conditions.

The invention has for its object to remedy or reduce at least one of the drawbacks of the prior art or at least provide a useful alternative to the prior art.

The object is achieved through features which are specified in the description below and in the claims that follow.

A self-adjusting foil suspension is provided, in which a foil is placed in a fluid flow, typically a tidal flow, and in which the foil is rotatable around a rotational axis, and in which the foil suspension is characterized by the foil being connected to a track by means of an arm, the arm being rotatable around the rotational axis and rotatably connected to the track around an axis of suspension at a radial distance from the rotational axis, the axis of suspension being parallel to the rotational axis.

Thus, the foil has double hinging relative to the track and is thereby given a further freedom to adjust itself into a favourable position relative to the water flow. The invention also enables a simple flipping of the foil by a change in the flow direction. Such a change in the flow direction relative to the foil may occur, for example, by the foil getting into a part of the track in which the direction of the track has been changed, or by the direction of the water flow changing.

The rotational axis may be between the centre of lift of the foil and the, in the position of application, front portion of the foil. The rotational axis may be nearer to the front portion of the foil than to the centre of lift of the foil.

The position of the rotational axis relative to the profile of the foil must be adjusted to the prevailing conditions but a position near the front portion of the foil will, as a rule, be a favourable starting point.

The arm may be loaded to be rotated into a starting position relative to the foil. The starting position may typically be projecting rearwards from the front portion of the foil.

The loading may be provided by means of an elastic element, for example in the form of a spring or an elastic band. In larger plants, it may also be relevant to use gas springs or hydraulic springs. In some cases, systems based on gravity, such as a weight on a rope that extends over a pulley, may be favourable.

The arm may be rotatable against a releasable lock. For example, the lock may be arranged to stop the rotation of the arm around the rotational axis when the arm is projecting forwards relative to the front portion of the foil. The lock may be arranged to be released by a force exceeding a predetermined value.

The track may be constituted at least by a belt or a guide. The arm may be rotatably connected directly to a track in the form of, for example, a rope, a belt or a chain. In larger plants, a guide is beneficial, the arm being rotatably connected to the guide by way of a guide block or a guide dolly. A belt or chain of some known form is normally used to receive the displacing force from the foils and to keep several foils at the desired spacing.

The track may be provided with a switching body at least at one position along its extent. A switching body may be constituted by, for example, a pulley or a rail, against which the foil or components connected to the foil will strike.

A switching body may typically be arranged in a position where the direction of the track has been changed. The operations of switching bodies of different kinds are described in further detail in the embodiment describing part of the application.

Trials show that if a second row of foils is arranged behind a first row of foils seen in the flow direction, the foils in the first row may be adapted to pick up a portion of the available energy, whereas the foils in the second row may pick up a further portion of the available energy. This is particularly favourable if the fluid flow exceeds a maximum design rate in the most favourable angle of attack of the foil relative to the flow direction. The foil may then rotate into a smaller angle of attack and let more of the energy in the water through to the second row of foils.

The device according to the invention enables a substantial improvement in the self-adjustment of foils, especially by flow rates near and over the permitted speed of the foil in the water at the most favourable angle of attack.

In what follows, an example of a preferred embodiment is described, which is visualized in the accompanying drawings, in which:

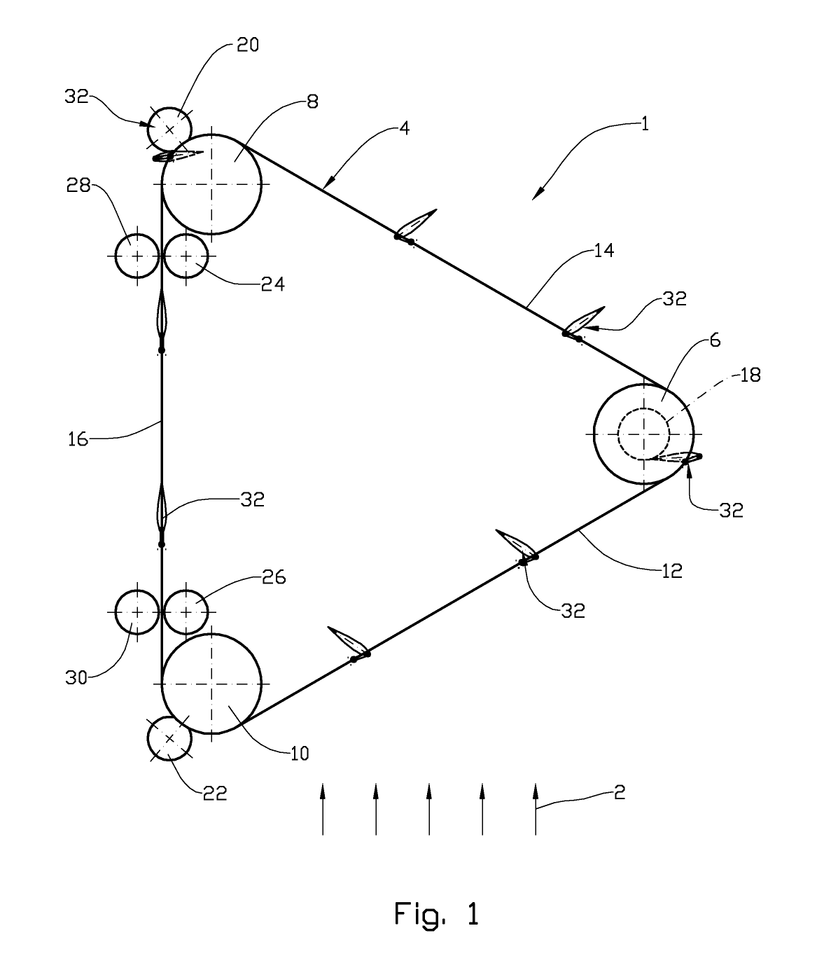

FIG. 1 shows schematically a plan view of an energy plant according to the invention;

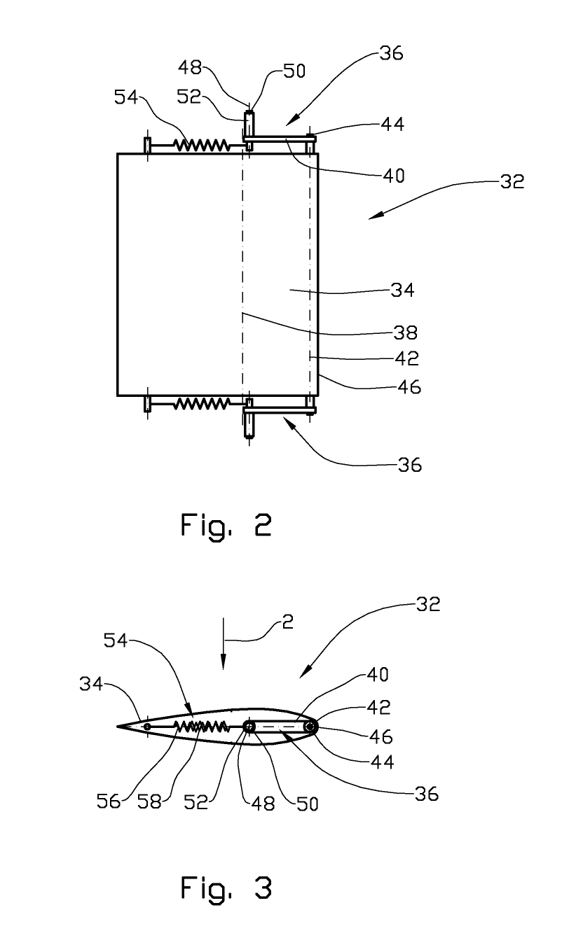

FIG. 2 shows a side view of a foil assembly according to the invention;

FIG. 3 shows a plan view of the foil assembly of FIG. 2;

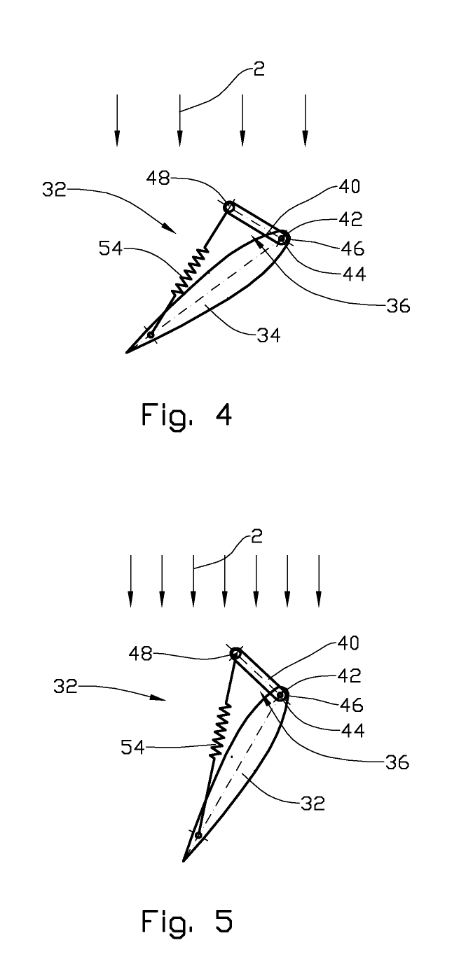

FIG. 4 shows the same as FIG. 3 but after a foil has adjusted itself relative to the water flow;

FIG. 5 shows the same as FIG. 4, but after the foil has further adjusted itself relative to the water flow;

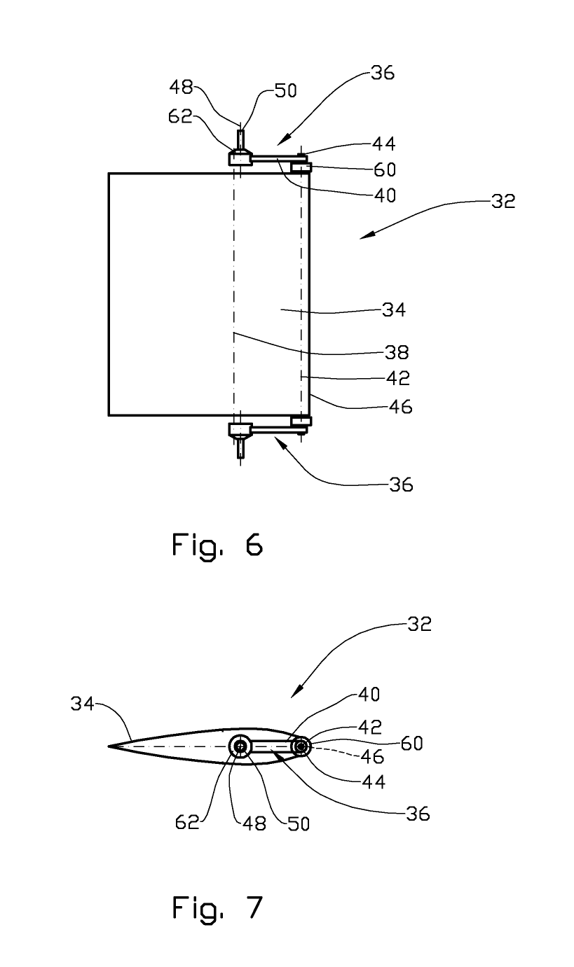

FIG. 6 shows a side view of a foil assembly adapted for the plant of FIG. 1; and

FIG. 7 shows a plan view of the foil assembly of FIG. 6.

In the drawings, the reference numeral 1 indicates an energy plant for extracting energy from a fluid flow 2 which is indicated by arrows in the drawings. The energy plant 1 includes a track 4, here in the form of a rope extending around a first deflection pulley 6, a second deflection pulley 8 and a third deflection pulley 10. In this preferred exemplary embodiment, the track has a triangular shape. A first stretch 12 of the track 4 extends between the third deflection pulley 10 and the first deflection pulley 6. A second stretch 14 extends between the first deflection pulley and the second deflection pulley 8. The first and second stretches 12, 14 are placed at an angle to the fluid flow 2.

A third stretch 16 extending between the second deflection pulley 8 and the third deflection pulley 10 is, in the main, parallel to the flow direction of the fluid flow 2. The energy plant 1 is formed symmetrically to enable energy extraction from a tidal flow.

A switching body 18, here in the form of a switching pulley, is arranged at the first deflection pulley 6. A first activation body 20 is arranged at the second deflection pulley 8, whereas a second activation body 22 is arranged at the third deflection pulley 10. The activation bodies 20, 22 are arranged at an axial distance from their respective deflection pulleys 8, 10.

A stationary first supporting body 24 is arranged at the third stretch 16 of the track 4 at the second deflection pulley 8. Correspondingly, a stationary second supporting body 26 is arranged at the third deflection pulley 10. The supporting bodies 24 and 26 are here constituted by supporting pulleys.

Opposite the first supporting body 24, a first deactivation body 28 is arranged. Correspondingly, at the second supporting body 26, a second deactivation body 30 is arranged. The deactivation bodies 28, 30 are here constituted by deactivation pulleys. The track 4 extends, respectively, between the first supporting body 24 and the first deactivation body 28 and between the second supporting body 26 and the second deactivation body 30.

FIG. 2 shows a foil assembly 32 including a foil 34 and a self-adjusting foil suspension 36 at its, in the position of application, upper and lower portions. Terms like “upper” and “lower” refer to the exemplary embodiment shown, but, of course, the foil assemblies 32 may be used in other positions.

The foil 34 is formed to utilize, in accordance with known principles, the energy of flowing water. In the exemplary embodiment shown, in which the foil 34 is used in a tidal flow 2, the foil 34 is formed symmetrically. The foil 34 has a centre of lift 38 which is defined as being the point along the foil 34 in the direction of flow where the resultant lifting force is effective.

The foil suspension 36 includes an arm 40 which is rotatable around a rotational axis 42. A shaft 44, which is concentric to the rotational axis 42, extends through the foil 34 and arms 40 at the, in the position of application, front portion 46 of the foil.

The arm 40 is also rotatable around a suspension axis 48 which is at a radial distance from the rotational axis 42, and which is parallel to the rotational axis 42.

A suspension shaft 50 is attached to the arm 40 and is rotatable in a suspension sleeve 52. The suspension sleeve 52 is connected to the track 4. The track 4 is not shown in FIG. 2.

An elastic element 54 in the form of a spring package is mounted between the suspension shaft 50 and the foil 34. In the exemplary embodiment shown, the elastic element 54 includes a first spring 56 which stretches when the foil 34 rotates into its active position as it is shown in FIGS. 4 and 5. A second spring 58 comes into abutment only when the foil 34 is in its most favourable position relative to the fluid flow 2, and stretches only if a predetermined flow rate is exceeded. The position of the arm 40 as it is shown in FIGS. 3 and 7 constitutes the starting position of the arm 40.

FIGS. 6 and 7 show a foil assembly 32 which is adapted for the energy plant of FIG. 1 and in which the foil suspension 36 includes a guide sleeve 60 which is rotatable around the shaft 44. Further, the suspension shaft 50 which is connected to the track 4 is rotatably supported in a bearing housing 62 on the arm 40.

The elastic element 54 is not shown in FIGS. 6 and 7, but is here in the foil 34, the shaft 44 being fixedly connected to the arms 40.

The operation of the invention will now be explained first with respect to the foil assembly, reference being made to the FIGS. 2 to 5.

When the fluid flow 2 against the foil 34 increases, the foil 34 is rotated around the rotational axis 42 towards a favourable position relative to the fluid flow 2 while the first spring 56 in the elastic element 54 is being stretched, see FIGS. 4 and 5. The springs 56 and 58 are shown only in FIG. 3. The position of the suspension axis 48 relative to the centre of lift 38 has the effect of the foil 34 placing itself in a position favourable for the purpose at different fluid flow rates.

In the position as shown in FIG. 5, the second spring 58 of the elastic element 54 has come to its abutment, and the foil 34 is rotated further relative to the fluid flow 2 only if the velocity of the fluid flow 2 exceeds a predetermined value so that the second spring 58 is stretched as well.

The symmetrical design of the foil assembly 32 has the effect of the foil adjusting itself correctly by fluid flows 2 in both directions.

The operation of the energy plant 1 will now be explained with reference to FIGS. 1, 6 and 7.

In a foil assembly 32 which is moved along the first stretch 12 of the track 4, the foil 34 has adjusted itself into a favourable position relative to the fluid flow 2. The force from the fluid flow 2 acting on the foil 34 is transmitted to the track 4 and further via the first deflection pulley 6 to a generator not shown.

As the foil assembly 32 gets to the first deflection pulley 6, the foil 34 hits the switching body 18. By the very fact of the travel of the track 4 continuing, the suspension axis 48 is pulled along by the track 4, whereby the arm 40 is flipped to the opposite side of the foil 34 and is thereby made ready to adjust itself relative to the fluid flow 2 when the foil assembly 32 is moved along to the second stretch 14 of the track 4.

When the foil assembly 32 has passed the second deflection pulley 8, the guide sleeves 60 come to strike against the first deactivation body 28. The first supporting body 24 prevents the guide sleeves 60 from moving sideways relative to the track 4. Thereby the foil 34 cannot pass until it has been straightened along the track 4 by the arm 40 having been rotated by the track 4 into a position in which it projects forwards from the front portion 46. In this position, the arm 40 is locked relative to the foil 34 by means of a releasable lock not shown.

The foil assembly 32 is thus moved along the third stretch 16 of the track 4 without being able to adjust itself relative to the fluid flow 2.

When the foil assembly gets to the third deflection pulley 10, the guide sleeves 60 strike against the second activation body 22 which moves the releasable lock, not shown, out of its locking position. The foil 34 is thereby free to align in the fluid flow 2 when again the foil assembly 32 is moved into the first stretch 12 of the track 4.

The energy plant 1 functions equally well with fluid flows 2 from both tidal directions.

1. A device of a self-adjusting foil suspension in which a foil is placed in a fluid flow, typically a tidal flow, and in which the foil is rotatable around a rotational axis, wherein the foil is connected by an arm to a track, the arm being rotatable around the rotational axis and rotatably connected to the track around a suspension axis at a radial distance from the rotational axis, the suspension axis being parallel to the rotational axis.

2. The device in accordance with claim 1, wherein the rotational axis is between the center of lift of the foil and the, in the position of application, front portion of the foil.

3. The device in accordance with claim 1, wherein the rotational axis is nearer to the front portion of the foil than to the center of lift of the foil.

4. The device in accordance with claim 1, wherein the arm is loaded to be rotated towards as starting position relative to the foil.

5. The device in accordance with claim 4, wherein the loading is provided by an elastic element.

6. The device in accordance with claim 1, wherein the arm the is rotatable until it engages with a releasable lock.

7. The device in accordance with claim 1, wherein the track is constituted by at least a belt or a guide.

8. The device in accordance with claim 1, Wherein at least at one position, the track is provided with a switching body.

9. The device in accordance with claim 8, wherein the switching body is constituted by a pulley.

10. The device in accordance with claim 8, wherein the switching body is constituted by a rail.
